(19) United States
(12) Patent Application Publication
(10) Pub. No.: US 2006/0051486 A1
(43) Pub. Date: Mar. 9, 2006

(54) Pigment dispersion system

(75) Inventors: David Peter Dowdell, Glenfield (AU); Steven Arthur Wright, Woronara (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: CRODA SINGAPORE PTE LIMITED, Villawood (AU)

(21) Appl. No.: 11/170,299

(22) Filed: Jun. 29, 2005

Related U.S. Application Data
(60) Provisional application No. 60/583,847, filed on Jun. 29, 2004.

(51) Int. Cl. A23D 9/00

(52) U.S. Cl. 426/601

(57) ABSTRACT

Preblends and preblend systems can be produced for use in, amongst other things, sunscreen products. These preblend systems and preblends can have high pigment loads, generally low viscosity and a relatively high thixotropic index making it both easy to use and very stable. Finished products including preblends and preblend systems are also described.

### CROSS-REFERENCE TO RELATED APPLICATIONS

This application claims the benefit of the filing date of U.S. Provisional Patent Application No. 60/583,847 filed Jun. 29, 2004, the disclosure of which is hereby incorporated herein by reference.

### BACKGROUND OF THE INVENTION

Formulating high SPF (greater than SPF 10) sunscreens can be very challenging. Because of the relatively high pigment loads, it can be difficult to process these materials. In addition, it is often difficult to obtain the proper homogenous distribution of the pigments. Obtaining a fine particle distribution, proper dispersion and processability are all nontrivial issues. Indeed, use of expensive and time consuming high sheer mixing can be required, which can impact on the cost and efficiency of producing these materials.

One purported solution to these problems is described in U.S. Pat. No. 6,540,986. This patent describes mixtures which are oil-in-water emulsions containing an oil phase based on an oil that is the reaction product of a polyol and carboxylated alkoxylated alcohols with anionic emulsifying agents. The '986 patent demonstrates that nonionic emulsifiers are incapable of providing comparatively high pigment loads, e.g., high levels of SPF value.

Another patent of interest is U.S. Pat. No. 6,165,450, which describes a sprayable sunscreen which is an oil-in-water suspoemulsion containing, inter alia, dispersing agents.

It has now been found that good processability and high pigment loads can in fact be obtained using nonionic emulsifying agents when formulated in accordance with the present invention.

### SUMMARY OF THE INVENTION

The present invention provides formulations which can be used as a preblend for making sunscreens or other personal care products and colored cosmetics, can be used directly as a sunscreen or can be further compounded into oil-in-water or water-in-oil emulsions or other forms of personal care or cosmetic products. The invention also relates to “preblend systems” which may be used to make preblends. Both preblends and preblend systems are generally anhydrous—containing less than about 10% water by weight, preferably less than 5% water w/w. Preferably, the preblends and preblend systems of the invention are water free dispersions (less than 2% water). However, it is not unusual for the components used in the preblends and preblend systems to include some amount of moisture. For example, certain proteins may be used in making sunscreen formulations and they may be supplied in as much as 98% water by weight. Pigments used to make preblends may also have an associated water content. Depending upon the components used and their respective levels of water, preblends and preblend systems of the present invention may include up to about 10% water at which level they may be either dispersions or water-in-oil emulsions. When water free, these formulations can be formulated in a preservative free manner. This may be of great benefit to users with sensitive skin, allergies to particular preservatives and the like.

In another embodiment, sunscreen formulations of the invention can be produced using the preblend or preblend systems of the present invention. These sunscreen formulations may continue to be generally anhydrous or may contain significant amounts of water forming, for example, oil-in-water emulsions, suspensions and the like.

Traditionally, sunscreen manufacturers made a “preblend.” This included a dispersion or emulsion system of a standard amount of pigment. Often, the preblend was nothing more than a pigment and a substrate. The preblend was then used as a single component and metered out, on a percent active basis, into sunscreen formulations. A preblend in accordance with the present invention has the same meaning. However, a “preblend system” as used herein is a preblend prior to the addition of pigment. Preblends and preblend systems in accordance with the present invention can also be blended into, for example, personal care products such as shampoos, conditioners, hair sprays and colored cosmetics such as, without limitation, foundation, lipstick, blush, eye make-up and the like, hair treatment products, skin treatment products and the like. They may also be used in sunscreens including sunscreen sprays for the hair and skin and may be applied using pumps or aerosol containers. They may be applied as milks or oils, or thickened to creams or lotions.

A particularly preferred preblend system in accordance with one aspect of the invention includes a nonionic emulsifier, an emollient ester and a substrate. A preblend according to the invention includes this preblend system and at least one pigment. In an embodiment, the preblend system of the present invention includes as an emollient ester one or more compounds based on reaction products of a monoprotic or monocarboxylic acid or a di- or tri-carboxylic acid which has been reacted with fatty alcohols of between about 6 and about 22 carbons and between 2 and about 50 units of an alkoxy group of 2 to 3 carbons in length. It should be understood that acids, fatty acids, fatty alcohols an alkoxy groups used in reactions to produce the emollient esters of the present invention often contain a variety of similar compounds of various carbon chain lengths. Thus, when the application suggests using, for example, a fatty alcohol of 12 carbons, it should be understood that that means that at least the predominant fraction of the materials used have that length—even though that fraction might not even be a majority of the fatty alcohol present. Similarly, a recitation of, for example, 6 to 22 carbons means that adding the proportions of all of the fatty alcohols in the raw material or the finished esters having a carbon chain length of 6 to 22 carbons should result in the predominant fraction of all fatty acids with the others being considered singularly. Thus, if the content of 6 to 22 carbon chain fatty alcohols totaled 19%, no other fatty alcohol should be present in an amount of 19% or more. This is true for the other species (alkoxy, acids and the like) as well.

Even more preferably, the formulation includes either a di- or tri-carboxylic acid derivative having between 4 to 6 carbons. In one embodiment, these emollient esters are provided in an amount of between about 5 to about 50%, and in another embodiment, between about 5 to about 30%, and in yet another embodiment, between about 5 to about 20% by weight of the preblend system. The nonionic emulsifier preferably can be present in the same amounts as just described in connection with the emollient ester. However, in a preferred embodiment, the nonionic emulsifier is selected from the group consisting of sorbitan derivatives, glycerol derivatives, polyglycerol derivatives, alkoxylated fatty acids, alkoxylated fatty alcohols, and the like. In another embodiment, the nonionic emulsifiers are selected from the group consisting of sorbitan oleates, sorbitan isostearates, alkoxylated fatty acids, alkoxylated fatty alcohols, glycerol mono-oleates, glycerol isostearates, polyglycerol oleates and polyglycerol isostearates.

Finally, the substrates are preferably natural or synthetic oils such as, for example, polyisobutene, dimethicone vegetable oil, castor oil or mineral oil, or esters of mono-, di-, or triglyceride based materials. The fatty acid species used to form these gylcerides generally include a short chain fatty acid species of 16 carbons or less. It is recognized, however, that sources of such fatty acids are normally fatty acid based species which are normally not homogenous and thus the predominant species contained within any mixture uses raw materials will have a chain length of about 16 carbons or less.

Preblends and preblend systems of the present invention have significant advantages when compared to known systems. First, they can be made using traditional low sheer mixers, such as paddle mixers, as opposed to high sheer mixers. Indeed, when compared to a preblend of 35% by weight Titanium Dioxide and 65% Crodamol GTCC [Capric/Caprylic Triglyceride], a preblend in accordance with the present invention of Cromollient DP3A [Di-PPG-3 Myristyl Ether Adipate], CRILL 6 [Sorbitan Isostearate] and CRODAMOL GTCC having the same weight percentage of pigment, produced viscosities of about 50% less. Viscosity was measured by a Brookfield viscosity device using spindle 6 at 50 rpm. In addition, the prior formulation of CRODAMOL GTCC and pigment alone required high sheer mixing. The thixotropic index of the conventional material was approximately 3.5. The thixotropic index of a preblend made from the preblend system of the present invention, however, was approximately 100% greater. Thus, not only was the preblend of the present invention more easily produced, but it provides advantages in terms of processing inasmuch as it flows and blends considerably better while at the same time being more stable.

In another embodiment, the preblend systems in accordance with the present invention comprise a nonionic emulsifier and an emollient ester which is a monocarboxylic, dicarboxylic acid ester or tricarboxylic acid ester of alkoxylated fatty alcohols wherein the fatty portion of the alkoxy alcohols range from between about 6 to about 22 carbons. The acid generally contains between about 2 and 12 carbons, although for the monocarboxylic acids, the range of the carbon chain is from about 4 to about 16 carbons. These may be substituted or unsubstituted, branched or linear, saturated or unsaturated. Finally, the preblend system includes a substrate which is preferably a substituted mono-, di- or tri-glyceride substituted with at least one short chain fatty group as long as no greater than 10% of substitutions group contain more than 16 carbons in length or a natural or synthetic oil. These blends of nonionic emulsifiers, emollient esters and substrates can act as the preblend systems to which pigments, such as titanium dioxide, zinc oxide or pigments used in color cosmetics can be added. Indeed, titanium dioxide and other pigments can be added at any point in the blending process of these three ingredients. The result is good dispersibility, high loads and SPFs, stable formulations with generally lower than expected viscosity and higher thixotropic index.

It has been found that these preblend systems provide unique properties in terms of processability, ability to disperse pigment and pigment loading. The invention includes preblend systems, preblends and sunscreen formulations made using either. In another aspect of the present invention, there are contemplated anhydrous dispersions or anhydrous water-in-oil emulsions (about 10% water content or less) of nonionic emulsifiers, emollient esters, substrates and pigments. Methods of making these are also contemplated. Another preferred aspect of the present invention is a sunscreen having a thixotropic index which is at least 30% higher and a viscosity which is at least 30% lower than that which would result from a formulation which does not include a nonionic emulsifier and an emollient ester in accordance with the invention (e.g. pigment and CRODAMOL GTCC). More preferably, the thixotropic index is about 50% higher and the viscosity is about 50% lower.

In one embodiment of the present invention, the preblend system consists essentially of a nonionic emulsifier, an emollient ester and a substrate as defined herein.

In another embodiment, the preblend system consists essentially of a mixture of a nonionic emulsifier in an amount of about 5 and about 50% by weight, an emollient ester which is a monocarboxylic acid, dicarboxylic acid or tricarboxylic acid ester of alkoxylated fatty alcohols whose acid portion have about 2 to about 12 carbons, fatty portions range from about 6 and 22 carbons in length, provided in an amount which ranges from about 5 to about 50% by weight and a substrate selected from esters and oils, provided in an amount which ranges from about 20 to about 90% by weight, and wherein the weights are measured against the total weight of said preblend system.

In the context of a preblend system, the term “consisting essentially of” is meant to exclude the presences of other ingredients and/or amounts of other ingredients that would generally be necessary for sale of the resulting product to retail customers and end users. In the context of preblend systems, but not preblends per se, it would also exclude pigments. Thus, for example only, a preblend system consisting essentially of a nonionic emulsifier, an emollient ester and a substrate could also include, without limitation, a microbial preservative. While this same preservative could be used in the same amount in a final product, the preblend system including same, while generally suitable for sale to product manufacturers who will compound it with other conventional ingredients, is not a suitable end product for application to the skin as a stand-alone product. A preblend consisting essentially of a nonionic emulsifier, an emollient ester and a substrate as defined herein is the same as a preblend system just described, however, it includes pigment.

In a particularly preferred embodiment, preblends and preblend systems of the invention which consist essentially of a nonionic emulsifier, an emollient ester and a substrate as defined herein exclude more that about 10% total of anything that does not fall within the definition of these terms (preblends include pigments of course).

### BRIEF DESCRIPTION OF THE FIGURES

FIG. 1 illustrates the dispersion viscosity of various mixtures.

FIG. 2 illustrates the thixotropic index of various mixtures.

### DETAILED DESCRIPTION

The term “comprising” as used herein is open-ended and includes anything in addition to the recited elements. “Consisting essentially of” is defined herein. “Between” in connection with a range includes its endpoints.

The emollient esters in accordance with the present invention are derived from monocarboxylic acids of 4 to 18 carbons in length, dicarboxylic or tricarboxylic acids, which may range from 2 to 12 carbons in length. A particularly preferred tricarboxylic acid is citric acid which contains 6 carbons. Particularly preferred dicarboxylic acids include adipic (6 carbons), maleic (4 carbons), succinic (4 carbons). A particularly preferred monocarboxylic acid or monoprotic acid is PPG-3 myristyl ether neoheptanoate. These carboxylic acid species may be substituted or unsubstituted, straight chain or branch. They may also be saturated or unsaturated. Di- and tri-carboxylic acids are most preferred. Particularly preferred are emollient esters based on citric and/or adipic acid.

Most preferably, the predominant fraction of the materials used in the emollient ester are exhaustively esterified with alkoxy alcohols. Thus, all of the carboxylic acid groups of the acid are bound, preferably through one or more alkoxy groups, to a fatty alcohol.

The fatty alcohols may be straight or branched, substituted or unsubstituted, saturated, unsaturated or polyunsaturated. They preferably have between 6 and 22 carbons in length, more preferably between 10 and 18 carbons in length. It is not necessary that each fatty alcohol group be the same, and thus these emollient esters may be asymmetrically substituted.

The alkoxy groups useful in the emollient esters in accordance with the present invention are generally short chain alkoxy groups of between 2 and 3 carbons. They include ethoxy substituents and propoxy substituents. Most preferred of the propoxy groups are the branch propoxy, where a methyl substituent is on the first or second carbon of the group. Of course, these may be mixed as well. Alkoxy substituents can be homogenous (for example, all ethyoxy) or may be a mixture of ethoxy and propoxy and/or a mixture of different forms of propoxy materials. Where different forms of propoxy and/or propoxy and ethyoxy groups are used, the order can be random or in blocks. Each group may be considered a separate unit and the number of alkoxy units will generally range from between 1 and 50, preferably between 1 and 30, more preferably between 2 and 15. The alkoxy substituents may also be asymmetrical. Therefore, using a diacid, one could have a first fatty alcohol substituent and a first alkoxy substituent, which is different in composition and length than the alkoxy substituent and the fatty alcohol substituent bound to the other side of the diacid. And, while it is preferred that the materials be all one form, it is understood that the emollient esters are often a mixture of various reaction products. However, they should contain at least a significant fraction of the specifically desired compound.

Particularly preferred emollient esters in accordance with the present invention include esters based on alkoxylated alcohols. A particularly preferred one is known as CROMOLLIENT DP3A by Croda, Inc. USA of Edison, N.J., which is a 3 propylene oxide myristyl alcohol adipate diester. Another preferred emollient ester is 3 propylene oxide myristyl alcohol citrate triester.

Substrates in accordance with the present invention are generally either esters or oils. Esters can include such compounds as octyl stearate or mono-, di- or triglyceride based materials. Triglycerides are preferred and these preferably include as a predominant fraction triglycerides which are exhaustively esterified. It is possible to use diglycerides, monoglycerides and mixtures. Understand, however, that in esterifying triglycerides, it is often the case that monoglycerides and diglycerides may result in some proportion as well. Moreover, to the extent that more than one fatty acid substituent is used, the distribution of these on the glyceride backbone may vary. Other esters that may be used include so-called UV-absorbing esters such as octyl methoxy cinnamate and the like.

Oils include any natural or synthetic oil including, without limitation, polyisobutene and the like. These can include silicon based oils and materials such as dimethicone and cyclomethicone, vegetable oils, castor and mineral oil.

As noted previously, it is preferred that the fatty acid species used to form the triglycerides in accordance with the present invention include generally short chain fatty acid species. Most preferably, these will have a chain length of 16 carbons or less although up to about 10% by weight of the starting material may have a chain length greater than C16. Most preferably, they range from about C6 to about C14. The acid species can be saturated or unsaturated, linear or branched, substituted or unsubstituted. Preferred substrates in accordance with the invention include short chain (mostly based on C14 acids or less) triglycerides. A partially preferred glyceride is CRODAMOL GTCC, which is a Caprylic/Capric triglyceride, sold by Croda, Inc. USA.

Any nonionic emulsifier may be used in accordance with the present invention as long as it is sufficiently compatible with the other excipients and will allow for the production of blends capable of carrying a sufficient load of pigment. Particularly preferred nonionic emulsifiers in accordance with the present invention are various sorbitan derivatives, including sorbitan oleates and sorbitan isostearates. Other well-known nonionic emulsifiers which may be used in accordance with the present invention include alkoxylated fatty acids or alkoxylated fatty alcohols. Various glycerol derivatives such as glycerol monooleate or glycerol isostearate, as well as polyglycerols such as oleates and isostearates may also be used. Any of the foregoing are preferably branched and/or unsaturated. One particularly preferred nonionic is CRILL 6, a sorbitan isostearate, available from Croda, Inc. USA.

Pigment as used in accordance with the present invention generally refers to a dry powder material such as titanium dioxide, zinc oxide, carbon black, iron oxides, hydrophobically coated pigments and organic pigments such as Phthalocyanine. Some of these materials can also be, as is known in the industry, treated or surface coated with various materials. These coatings are known for use in enhancing dispersibility. Such coatings include Dimethicone and Trimethoxycaprylylsilane and the like.

Preferably the amount of the nonionic emulsifier in the preblend system, also referred to herein as a “base,” will range from between about 5 to about 50 percent, preferably about 5 to about 30%, more preferably between about 5 and about 20 percent by weight based on the weight of the preblend system. The amount of emollient ester in accordance with the present invention will generally range from between about 5 to about 50 percent, preferably about 5 to about 30%, more preferably between about 5 and about 20 percent by weight based on the weight of the preblend system. The balance will be substrate, typically this will range from between about 20 to about 90 percent, preferably between about 40 and 80 percent by weight based on the weight of the preblend system. These are weight percents based on the total weight of the combination of the nonionic emulsifier, the emollient ester and the substrate. It is also possible to include traditional amounts of other conventional materials as additives. These could include, for example, other types of emollients, other types of substrates or emulsifiers, preservatives, viscosity modifiers, solvents and the like.

Preblends in accordance with the present invention will generally also include at least one pigment, in an amount of between about 2 and about 60 percent pigment by weight, more preferably 5 to about 60 percent of a pigment by weight of the preblend. Preferably the pigment is a microfine titanium dioxide. A particularly preferred formulation in accordance with the present invention includes about 55-75 percent of a preblend system in accordance with the present invention and about 45-25 percent of a pigment. One particularly preferred preblend is about 60-70 percent preblend system and about 30-40 percent pigment. Another preferred embodiment has about 65 percent preblend system and about 35 percent pigment.

The three materials that make up the preblend system or base can be added into a suitable vessel equipped with a propeller type stirrer. While stirring at moderate speed, the pigment can be added in small portions, allowing full dispersion of each addition before additional material is added. When all the solid has been added, the mixing speed can be increased for about 10 to 15 minutes or until a uniform and aggregate free dispersion is obtained (“homogenous”). It is possible to use high sheer mixtures such as a Silverson. However, the advantage of the present invention is that such high sheer mixing is not generally necessary. A silverson is high shear mixer, blades spin at high RPM creating high pressure points around the blade in contact with the mix and this high-energy system will detrimentally break up particles of pigment. A low shear mixer is paddle or propeller mixer. The mixer can be operated at very low RPM and therefore does not use physical force or shear to further reduce particle size. Particle size analysis of titanium dioxide dispersions made under slow speed, nonhigh sheer mixing for 5 minutes using the base of the present invention was generally equal to or better than the titanium dioxide dispersions produced using a Silverson for 20 minutes. In addition, reduced viscosities were realized, and increases in thixotropy were realized, making the pigment very easy to disperse in about 25 percent of the time required using a much higher sheer technique such as a Silverson.

As previously noted, the base or preblend system, or indeed any preblend, may be used alone or may be used in combination with other materials. In one embodiment, additional chemical based UV blocking or absorbing species are used. Generally these are used in conventional amounts ranging in an amount generally up to about 25% by weight of the total formulation. These can be UVA, UVB or UVC absorbing materials such as avobenzone, Methoxycinnamate esters, Octocrylene, Butyl Methoxy dibenzoylmethane, Ethylhexyl Triazone and the like. Other additional ingredients generally known in modern sunscreen systems which can be used in accordance with the present invention include polymeric thickeners and stabilizers, additional emollients, emollient oils, microbial preservatives (necessary if water is used), antioxidants, fragrances, humectants. These are typically used in known amounts.

Sunscreen formulations in accordance with the present invention can be produced in a number of ways. In the most traditional approach, one can take a preblend including the preblend system of the present invention and a pigment and meter it into a blending vessel along with the other components of the sunscreen as is traditionally done. However, because of the generally reduced viscosity and high dispersibility of the present invention, one can take a preblend system of the present invention, without pigment, can add it and pigment separately, to a blending vessel and add the additional components. This can all be blended in a single step. This saves additional blend time. Moreover, because of the advantages of the preblend system of the present invention, one need not use high sheer mixing, generally even in the production of the final product.

Alternatively, one can take the individual components of the preblend system and in particular the nonionic emulsifier and the emollient ester and add them, along with a substrate and any additives, to a blending vessel as individual components, along with the pigment, and blend them together in a single step. This is a great advantage in terms of processability, time and efficiency.

Sunscreen formulations produced in any of these methods should include at least about 0.5% of an emollient ester, more preferably at least about 1.0% of an emollient ester, and more preferably at least about 2.0% of an emollient ester. 4.5% of an emollient ester has been found to be particularly useful. The same general percentages can be used for the nonionic emulsifier. There is largely no upper limit for either of these ingredients although at some point the use of too much of the emulsifier could present a problem. However, in general, the total of the emollient ester and the nonionic emulsifier should be no more than 35% of the total weight of the formulation, more preferably 30% or less thereof. The balance will be pigments, substrates and additives. Generally the amount of pigment in the final material will be sufficient to provide it with a SPF of at least 5 and up to an SPF of about 50. The amount of pigment can range from between about 1 to about 75 weight percent, more preferably between about 2 to about 60 weight percent, most preferably between about 3 to about 45 weight percent. Again as noted earlier, the balance will be substrate and/or traditional additives such as preservatives, colorings, fragrances, viscosity and reology modifiers, stabilizers and the like. It is possible to use a single substrate material such as, for example, CRODAMOL GTCC. However, more frequently, in final formulations, a variety of such substrates will be used.

The preblends and final products may be used in a liquid or, because of their lower viscosity, aerosol form, and can be incorporated into various cosmetic and personal care products such as hand and body lotions, sunscreens, oils, ointments, lip balm products, facial cosmetics and the like as well as compositions for treating hair. This preblend system can also be used to disperse certain hair dye stuffs, particularly those requiring predispersion before incorporating into hair color products.

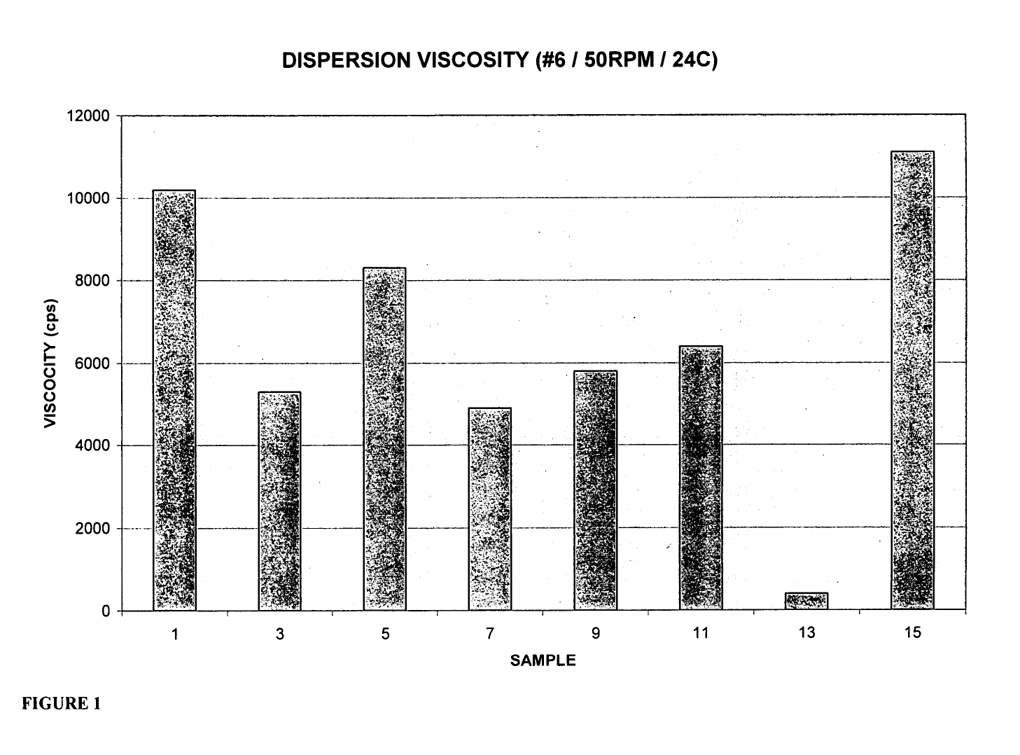

As shown in the tables below and the accompanying FIG. 1, the viscosity of various formulations were measured. These were done using Brookfield viscosity equipment with a number 6 spindle at 50 rpm.

TABLE 1a

| GTCC | DP3A | CRILL 6 | M170 | ZNO 35% | SAMPLE | 50 RPM |
|---|---|---|---|---|---|---|
| 65.0 | | | 35.0 | | 1 | 10200 |
| 55.0 | | 10.0 | 35.0 | | 3 | 5300 |
| 55.0 | 10.0 | | 35.0 | | 5 | 8300 |
| 45.0 | 10.0 | 10.0 | 35.0 | | 7 | 4900 |
| 35.0 | 20.0 | 10.0 | 35.0 | | 9 | 5800 |
| 35.0 | 10.0 | 20.0 | 35.0 | | 11 | 6400 |
| 33.5 | 10.0 | 10.0 | 35.0 | 11.5 | 13 | 400 |
| 53.5 | | | 35.0 | 11.5 | 15 | 11100 |

TABLE 1b

| GTCC | DP3A | CRILL 6 | M170 | ZNO 35% | SAMPLE | 5 RPM |
|---|---|---|---|---|---|---|
| 65.0 | | | 35.0 | | 1 | 36000 |
| 55.0 | | 10.0 | 35.0 | | 3 | 31000 |
| 55.0 | 10.0 | | 35.0 | | 5 | 67000 |
| 45.0 | 10.0 | 10.0 | 35.0 | | 7 | 33000 |
| 35.0 | 20.0 | 10.0 | 35.0 | | 9 | 25600 |
| 35.0 | 10.0 | 20.0 | 35.0 | | 11 | 43000 |
| 33.5 | 10.0 | 10.0 | 35.0 | 11.5 | 13 | 17000 |
| 53.5 | | | 35.0 | 11.5 | 15 | 84000 |

In the above tables, CRODAMOL GTCC, CROMOLLIENT DP3A and CRILL 6 have their prior meaning. M170 is a brand of titanium dioxide referred to elsewhere herein. ZNO 35% is a zinc oxide available from Advance Nano Technologies Pty Ltd. Perth, Australia. As previously noted, traditional formulations use a material such as CRODAMOL GTCC alone and titanium dioxide. This is shown in Table 1 as Sample 1. The resulting viscosity is 10,200 centipoises. This should be compared with, in particular, a blend of 45% CRODAMOL GTCC, 10% CROMOLLIENT DP3A, 6% CRILL 6 and 35% titanium dioxide shown in Table 1 as Sample 7, where the resulting viscosity was less than half that of sample 1.

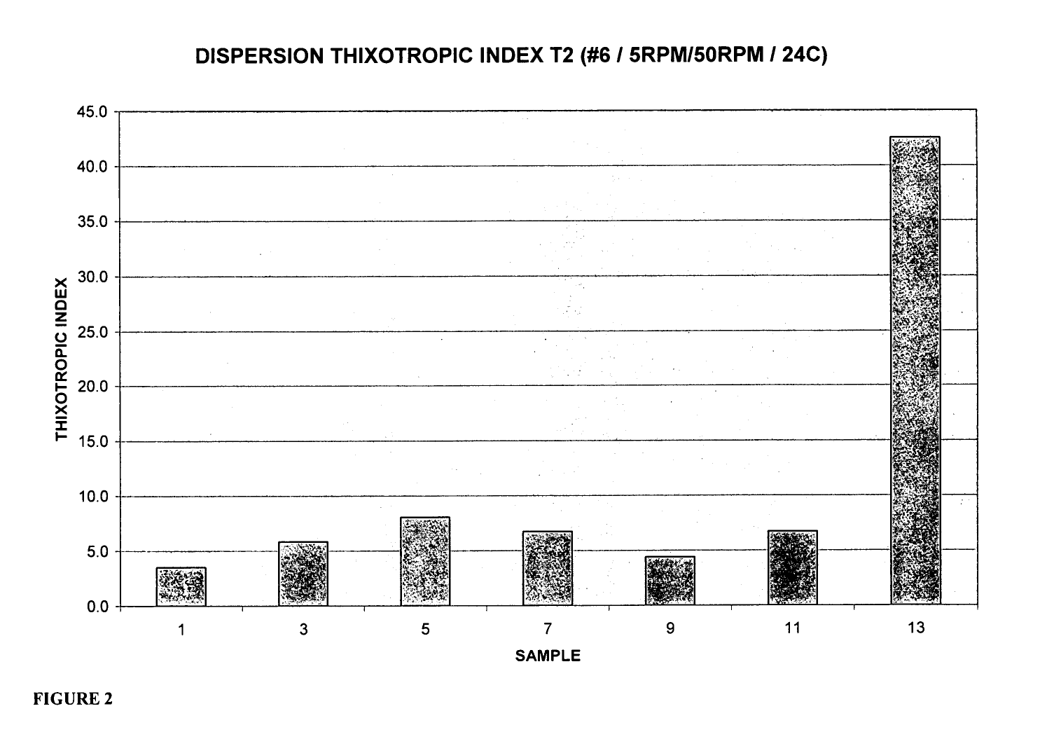

As shown in Table 2 and the accompanying FIG. 2, the same formulations were tested for thixotropic index, which is taken as a multiple of 10 from rpm's from two readings, i.e. 5 rpm (Table 1b) and 50 rpm (Table 1a), then divided the low rpm by the higher rpm number. Again these results were obtained by using Brookfield viscosity equipment with a number 6 spindle at 5/50 rpm as indicated. The thixotropic index “TI.2” in Table 2 for a CRODAMOL GTCC and titanium dioxide formulation (Sample 1) was 3.5. However, Sample 7 had a thixotropic index of almost twice that at 6.7. This illustrates the ability to obtain, at once, lower viscosity and therefore better processing characteristics and greater stability by the use of the present invention.

TABLE 2

| GTCC | DP3A | CRILL 6 | M170 | ZNO 35% | SAMPLE | TI.2 |
|---|---|---|---|---|---|---|
| 65.0 | | | 35.0 | | 1 | 3.5 |
| 55.0 | | 10.0 | 35.0 | | 3 | 5.8 |
| 55.0 | 10.0 | | 35.0 | | 5 | 8.1 |
| 45.0 | 10.0 | 10.0 | 35.0 | | 7 | 6.7 |
| 35.0 | 20.0 | 10.0 | 35.0 | | 9 | 4.4 |
| 35.0 | 10.0 | 20.0 | 35.0 | | 11 | 6.7 |
| 33.5 | 10.0 | 10.0 | 35.0 | 11.5 | 13 | 42.5 |
| 53.5 | | | 35.0 | 11.5 | 15 | 7.6 |

A particularly preferred preblend system in accordance with the present invention is one which includes 64% by weight of CRODAMOL GTCC, 18% of CROMOLLIENT DP3A and 18% of Crill 6 with each of the components being by weight based on the total weight of the preblend system. The preblend is prepared by mixing 64% by weight of CRODAMOL GTCC, 18% of CROMOLLIENT DP3A and 18% of CRILL 6 together using a paddle or propeller mixer until an homogenous mixture results.

Color cosmetics in accordance with the present invention can be made using the preblend and preblend systems described herein. A color cosmetic means a cosmetic product meant to provide color to the skin, hair or nails to which it is applied. Pigments, which may be used in color cosmetics, can include but are not limited to those previously described as well as hydrophobic or hydrophobically coated pigments and pigment combinations. These pigments may be mixed into a preblend system in accordance with the present invention such as a preblend system made from 64% CRODAMOL GTCC, 18% CROMOLLIENT DP3A and 18% Crill 6. The resulting preblend can then be used to produce color cosmetics such as, without limitation, lipstick, blush, rouge, mascara, foundation, eye shadow, eye pencils and eyeliners, nail polish and the like. In such context, the preblends and preblend systems of the present invention may be used as a conventional dispersing aid and/or as an emulsifier or carrier system to be used in color cosmetics. The amount of the preblend will depend largely on the amount of pigment to be included within the color cosmetic formulation. The preblend may be mixed with emollients, emulsifying agents, humectants, fillers, carriers, structuring agents, film forming agents, other pigments or coloring agents and the like as is known in the art in the creation of color cosmetics. The color cosmetics may be in the form of oil-in-water emulsions, water-in-oil emulsions, oil-in-oil emulsions, dispersions, suspensions, powders, gels, milks, lotions, creams and the like. Examples of such cosmetic products are; tinted moisturizers, tinted sunscreens, liquid foundations, mascara, lipsticks, lip balms and most other liquid semi-solid or solid colored cosmetic applications.

### EXAMPLE 1

Crodamol GTCC (caprylic/capric triglycerides available from Croda, Inc.) 69.2% w/w; Cromollient DP3A (Di PPG-3 Myristyl Ether Adipate available from Croda, Inc.) 15.4% w/w; Crill 6 (sorbitan isostearate available from Croda, Inc.) 15.4% w/w. The three base materials were blended in suitable equipment using a propeller stirrer. The pigment, UV Titan M-170 (available from Kemira), was added in small portions allowing dispersion of each addition before adding the next portion. When all of the solids were added such that the amount of pigment was 35% w/w with the balance, about 65% w/w, being the mixture of the other three ingredients, the mixing speed was increased until a uniform and aggregate free dispersion was obtained.

### EXAMPLE 2

A second formulation, a preblend system, can be produced by blending the following as described in Example 1.

| | |
|---|---|
| Crill 6 | 18% |
| Cromollient DP3A | 18% |
| Crodamol GTCC | 64% |

### EXAMPLE 3

A preblend is produced by adding 35% w/w of titanium dioxide M170 to 65% w/w of the preblend system of Example 2 and blending as in Example 1.

### EXAMPLE 4

Spray/Aerosol - Children's Inorganic Sunscreen Spray SPF 30+

| | |
|---|---|
| Crodasperse | 25% |
| Titanium Dioxide M170 | 16% |
| Super Hartolan | 5% |
| Medilan | 1% |
| Crodamol PMP | 2% |
| Keratec PEP | 4% |
| Crodamol GTCC | 53% |

All of the materials may be changed to a single vessel and mixed using low sheer until properly blended. For example, blending can be by slow speed mixing with a paddle mixer for 10 minutes at 75° C.

### EXAMPLE 5

Lotion/Cream - Children's Inorganic Sunscreen Cream SPF 30+

| | |
|---|---|
| Crodasperse | 25% |
| Titanium Dioxide M170 | 15% |
| Crodamol GTCC | 10.5% |
| Crodamol CAP | 10% |
| Crodamol PMP | 2% |
| Crodamol OS | 32% |
| Super Hartolan | 5% |
| Medilan | 1.5% |
| Crodamol HDS | 4% |
| Syncrowax HRC | 4% |
| Syncrowax ERLC | 2% |

All of the materials may be changed to a single vessel and mixed using low sheer until properly blended. For example, blending can be by slow speed mixing with a paddle mixer for 10 minutes at 75° C.

### EXAMPLE 6

| Lip Gloss | |
|---|---|
| Ingredients | % |
| PART A | |
| SYNCROWAX HRC (Tribehenin) | 5.00 |
| Microcrystalline Wax (1) | 7.00 |
| Carnauba Wax (2) | 1.00 |
| MEDILAN LIQUID ULTRA (Lanolin Oil) | 30.00 |
| CRODASPERSE SW | 5.00 |
| Castor Oil | 24.41 |
| Methylparaben | 0.20 |
| Propylparaben | 0.10 |
| PART B* | |
| Castor Oil | 6.50 |
| D&C Red 7 Lake | 1.55 |
| D&C Red 6 Lake | 1.55 |
| FD&C Blue Lake | 0.50 |
| PART C** | |
| Bismuth Oxychloride (3) in castor oil | 7.14 |
| PART D | |
| Mica (and) Titanium Dioxide (4) | 10.00 |
| PART E | |
| Ascorbyl Palmitate | 0.05 |

Procedure

Combine Part A ingredients and heat to 85-90° C. with mixing. Cooling to 75-80° C. and add color grind of Part B. When dispersed, add Part C premix. When dispersed, add Part D. Stir slowly, maintaining temperature at 75-80° C. until air dissipates. Add Part E. Stir until temperature cools to 67-69° C. and fill.

*Part B Color Grind: Combine ingredients of Part B Ina separate beaker, mixing by hand until all pigments are wet. Run color grind through a three-roller mill until particles of pigment are less than 10 μm. Check on Hegman.

**Part C Premix: Add 70% Bismuth Oxychloride to 30% castor oil in a separate beaker and hand-mix until completely wet and homogeneous.

1) Multiwax 180W (Ross Waxes)
2) Refined #1 Yellow Carnauba 356 (Ross Waxes)
3) Biron LF 2000 (Rona)
4) CRODASPERSE SW is a preblend system of the composition described in Example 2.

### EXAMPLE 7

| Lipstick with | |
|---|---|
| Ingredients | % |
| PART A | |
| Castor Oil | 26.70 |
| CRODAMOL PTIS (Pentaerythrityl Tetraisostearate) | 16.50 |
| CRODASPERSE SW | 11.00 |
| Candellila | 7.00 |
| SUPER STEROL ESTER (C10-30 Cholesterol/Lanosterol Esters) | 5.00 |
| Microcrystalline Wax (1) | 3.00 |
| Ozokerite 170D (1) | 2.00 |
| Carnauba | 1.75 |
| Methyl Paraben | 0.20 |
| Propyl Paraben | 0.10 |
| PART B | |
| Castor Oil | 13.05 |
| D&C Red No. 6 Barium Lake (3) | 3.10 |
| D&C Red No. 7 Calcium Lake (3) | 3.10 |
| D&C Blue No. 1 Lake (3) | 0.95 |
| PART C | |
| Mica (2) | 4.00 |
| Iron Oxides (and) Mica (4) | 2.00 |
| PART D | |
| Ascorbyl Palmitate | 0.05 |

Procedure

Combine ingredients of Part A and heat to 85-90° C., mixing until clear. Premix ingredients of Part B* and add to Part A, mixing until homogenous. At 70-75° C. stir in Part C after grind. Add Part D and fill into molds at 68-70° C.

### EXAMPLE 8

Oil-In-Water Foundation

| INGREDIENTS | % |
|---|---|
| PART A | |
| CRODAFOS CES (Cetearyl Alcohol (and) Dicetyl | 2.00 |
| Phosphate (and) Ceteth-10 Phosphate) | |
| VOLPO S-2 (Steareth-2) | 0.50 |
| VOLPO S-10 (Steareth-10) | 2.00 |
| CRODASPERSE SW | 13.00 |
| PART B | |
| Deionized water | 60.35 |
| KOH (10% Sol'n) | 0.93 |
| Polysorbate 61 (1) | 0.10 |
| Propylene Glycol | 4.00 |
| Magnesium aluminum silicate (2) | 1.00 |
| 80% Titanium Dioxide/talc (3) | 10.00 |
| 80% Yellow Iron Oxide/talc (3) | 1.00 |
| 80% Red Iron Oxide/talc (3) | 0.40 |
| 80% Black Iron Oxide/talc (3) | 0.08 |
| Talc (4) | 2.52 |
| PART C | |
| Carboxymethyl cellulose (5) | 0.12 |
| Propylene Glycol | 2.00 |
| Propylene Glycol (and) Imidazolidinyl Urea (and) | 1.00 |
| Propylene Glycol (and) Methyl Paraben (6) | |

pH = 7.85 ± 0.5
Viscosity = 3,500 cps ± 10% (RVT, Spindle #4, @ 20 rpm)

Procedure:

Combine the ingredients of Part A. Heat to 70-75° C. with propeller agitation. Combine the ingredients of Part B with homomixer agitation. Heat to 85-90° C. with mixing for fifteen minutes. Cool to 75-80° C. with mixing. Combine ingredients of Part C and add to Part B with mixing. Adjust temperature of both parts to 72-77° C. Slowly add combined Parts B/C to Part A with high speed propeller agitation. Maintain temperature and agitation for fifteen minutes. Air cool to 55° C. with moderate agitation. Check for water loss. Cool with water to 45° C. Add Part D. Continue to cool to 30° C. with slow agitation. Cool to desired fill temperature.
(1) Tween 61 (ICI)
(2) Veegum Regular (R. T. Vanderbilt)
(3) Cardre
(4) Altalc 400 (Luzenac)
(5) CMC7H3SF (Hercules)
(6) Germaben II (ISP/Sutton)

### EXAMPLE 9

Oil-In-Water Sunscreen Emulsion

| Ingredients | % |
|---|---|
| PART A | |
| CRODASPERSE SW | 10.0 |
| CRODAFOS N-3 NEUTRAL (DEA Oleth-3 Phosphate) | 0.5 |
| Zinc Oxide (1) | 3.0 |
| Titanium Dioxide (2) | 2.0 |
| PART B | |
| VOLPO S-10 (Steareth-10) | 1.0 |
| CRODAFOS CES (Cetearyl Alcohol (and) Dicetyl | 4.0 |
| Phosphate (and) Ceteth-10 Phosphate) | |
| PART C | |
| Deionized Water | 78.1 |
| Citric Acid Solution (10%) | 0.4 |
| PART D | |
| Propylene Glycol (and) Diazolidinyl Urea (and) | 1.0 |
| Methyl Paraben (and) Propyl Paraben (3) | |

pH = 6.0 ± 0.5;
Viscosity = 16,000 cps ± 10% (RVT, TC Spindle, 10 RPM @ 25° C.)

Procedure

Combine first two ingredients of Part A with mixing and heat to 50° C. Maintain temperature and slowly add zinc oxide and then titanium dioxide, mixing well after each addition. When uniform add the ingredients from Part B and heat to 70° C. with mixing. Combine ingredients in Part C, heat to 70° C. and slowly add to the Part A/B mixture. Continue mixing and cool to 65° C. Remove propeller mixer, insert homomixer and process batch to 60° C. Resume propeller mixing and cool to 45° C. Add Part D with mixing and cool to desired fill temperature.

### EXAMPLE 10

Water-In-Oil Diaper Rash Cream

| INGREDIENTS | % |
|---|---|
| PART A | |
| Mineral Oil | 23.0 |
| CRODASPERSE SW | 12.0 |
| Zinc Oxide (1) | 12.0 |
| CRODAFOS CES (Cetearyl Alcohol (and) | 6.0 |
| Dicetyl Phosphate (and) Ceteth-10 Phosphate) | |
| VOLPO S-10 (Steareth-10) | 2.0 |
| PART B | |
| Deionized Water | 44.1 |
| Methyl Paraben (and) Butyl Paraben (and) | 0.3 |
| Ethyl Paraben (and) Propyl Paraben (2) | |
| PART C | |
| Dimethicone (3) | 0.6 |

pH = 6.15 ± 0.5 (R.T.)
Viscosity = 70,000 cps ± 10% (Spindle #TD @ 10 rpm at R.T.)

Procedure

Combine first two ingredients of Part A and then disperse next ingredient into the mixture. Add remaining two ingredients with mixing and heat to 70-75° C. Combine Part B ingredients and heat to 70-75° C. When Part B reaches 70-75° C., add to Part A and mix well. Begin cooling and add Part C at 50° C. with mixing. Continue mixing and cool to desired fill temperature.

1. An anhydrous preblend system comprising: a mixture of a nonionic emulsifier in an amount of about 5 and about 30% by weight, an emollient ester which is a dicarboxylic acid or tricarboxylic acid ester of alkoxylated fatty alcohols whose acid portion have about 4 to about 6 carbons, fatty portion ranges from about 6 and 22 carbons in length, and which includes 1-50 alkoxy units, provided in an amount which ranges from about 5 to about 30% by weight and a substrate selected from esters and oils, provided in an amount which ranges from about 40 to about 90% by weight, and wherein the weights are measured against the total weight of said preblend system.

2. An anhydrous preblend system consisting essentially of a mixture of a nonionic emulsifier in an amount of about 5 and about 50% by weight, an emollient ester which is a monocarboxylic acid, dicarboxylic acid or tricarboxylic acid ester of alkoxylated fatty alcohols whose acid portion have about 2 to about 12 carbons, fatty portions range from about 6 and 22 carbons in length, and which includes 1-50 alkoxy units, provided in an amount which ranges from about 5 to about 50% by weight and a substrate selected from esters and oils, provided in an amount which ranges from about 20 to about 90% by weight, and wherein the weights are measured against the total weight of said preblend system.

3. The preblend system of claims 1 or 2 wherein said acid is selected from the group consisting of citric, adipic, maleic and succinic acids.

4. The preblend system of claim 3 wherein said acid is citric or adipic.

5. The preblend system of claims 1 or 2 wherein alkoxylated fatty alcohols include between about 1 and about 30 alkoxy units.

6. The preblend system of claim 5 wherein alkoxylated fatty alcohols include between about 2 and about 15 alkoxy units.

7. The preblend system of claim 3 wherein alkoxylated fatty alcohols include between about 1 and about 30 alkoxy units.

8. The preblend system of claim 7 wherein alkoxylated fatty alcohols include between about 2 and about 15 alkoxy units.

9. The preblend system of claims 1 or 2 wherein said nonionic emulsifier is selected from the groups consisting of sorbitans, alkoxylated fatty acids, alkoxylated fatty alcohols, glycerols and polyglycerols.

10. A preblend according to claims 1 or 2 further comprising between about 2 and about 60% pigment by weight of said preblend.

11. A method of dispersing pigment to form a preblend comprising the steps of: providing a preblend system of claims 1 or 2, and blending therewith at least one pigment in an amount of between about 2 and about 60% by weight based on the weight of said preblend, for a time sufficient to provide a homogenous preblend.

12. The method of claim 11 wherein said preblend is mixed under low shear.
